(19) United States
(12) Patent Application Publication
(10) Pub. No.: US 2026/0202719 A1
(43) Pub. Date: Jul. 16, 2026

(54) CAMERA MODULE

(71) Applicant: SAMSUNG ELECTRO-MECHANICS CO., LTD., Suwon-si (KR)

(72) Inventor: Jae Kyung KIM, Suwon-si (KR)

(73) Assignee: SAMSUNG ELECTRO-MECHANICS CO., LTD., Suwon-si (KR)

(21) Appl. No.: 19/447,171

(22) Filed: Jan. 13, 2026

(30) Foreign Application Priority Data
Jan. 13, 2025 (KR) 10-2025-0004969
Jul. 28, 2025 (KR) 10-2025-0102594

(51) Int. Cl. G03B 17/17; G03B 13/34; G03B 17/12; G03B 30/00; H04N 23/55; H04N 23/68

(52) U.S. Cl. CPC G03B 17/17; G03B 13/34; G03B 17/12; G03B 30/00; H04N 23/55; H04N 23/687; G03B 2205/0015; G03B 2205/0023; G03B 2205/0069; G03B 2217/002

(57) ABSTRACT

A camera module includes a housing having an internal space, a reflective member holder disposed in the internal space, the reflective member holder including a reflective member, a lens barrel spaced apart from the reflective member in an optical axis direction, and an image sensor spaced apart from the reflective member in a first axis direction intersecting the optical axis direction. The reflective member holder is coupled to a bottom surface of the housing. The lens barrel is configured to be movable, relatively with respect to the reflective member in one or more axis directions among three axis directions intersecting one another.

### CROSS-REFERENCE TO RELATED APPLICATIONS

This application claims the benefit under 35 USC 119(a) of Korean Patent Application Nos. 10-2025-0004969 filed on January 13, 2025, and 10-2025-0102594 filed on July 28, 2025, in the Korean Intellectual Property Office, the entire disclosures of which are incorporated herein by reference for all purposes.

### BACKGROUND

### 1. Field

The present disclosure relates to a camera module.

### 2. Description of the Background

Recently, camera modules have been adopted for use in portable electronic devices such as smartphones, tablet PCs, and notebook computers, and camera modules may have an autofocus (AF) function, an optical image stabilization (OIS) function, and a zoom function.

A camera module, having an AF function or an OIS function, has a limitation in reducing a size thereof. To solve such an issue, a camera module having a reflective member changing a path of incident light has been proposed.

However, a camera module may be formed to have a long total track length (TTL), and thus it may be difficult to apply to portable electronic devices having a limited installation space. In addition, in the camera module, a flare phenomenon may occur due to unnecessary light reflection caused by the long total track length, and image quality may be degraded due to the flare phenomenon.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing having an internal space, a reflective member holder disposed in the internal space, the reflective member holder including a reflective member, a lens barrel spaced apart from the reflective member in an optical axis direction, and an image sensor spaced apart from the reflective member in a first axis direction intersecting the optical axis direction. The reflective member holder is coupled to a bottom surface of the housing. The lens barrel is configured to be movable, relatively with respect to the reflective member in one or more axis directions among three axis directions intersecting one another.

The bottom surface of the housing may have a first through-hole exposing the internal space to the outside of the housing, and the reflective member holder may be disposed in the first through-hole.

A side surface of the housing may have a second through-hole exposing the internal space to the outside of the housing, the second through-hole disposed between the reflective member and the image sensor, and the reflective member holder may have an opening disposed parallel to the second through-hole, the opening disposed between the reflective member and the second through-hole.

The three axis directions may be the optical axis direction, the first axis direction, and a second axis direction perpendicular to both the optical axis direction and the first axis direction, and the lens barrel may be spaced apart from the reflective member upwardly in the optical axis direction.

The reflective member holder may include a flange portion parallel to the bottom surface of the housing, and the flange portion may be exposed to the outside of the bottom surface of the housing.

The flange portion may overlap the bottom surface of the housing in the optical axis direction.

A step portion, protruding toward a side surface of the housing, may be disposed on a side surface of the reflective member holder.

The flange portion and the step portion may overlap each other in the optical axis direction with the bottom surface of the housing interposed therebetween.

The bottom surface of the housing may include a plurality of first protrusions disposed between the reflective member holder and the image sensor to protrude toward the internal space, the plurality of first protrusions may extend in a second axis direction perpendicular to both the optical axis direction and the first axis direction.

The reflective member holder may include a plurality of second protrusions protruding toward a side surface of the reflective member, the plurality of second protrusions may extend in the optical axis direction.

The reflective member may include an incident surface on which light is incident, a reflective surface configured to reflect light passing through the incident surface, and an exit surface through which light reflected from the reflective surface exits, and the reflective surface and the exit surface may be spaced apart from each other.

The camera module may further include a lens holder coupled to the lens barrel, a carrier accommodating the lens holder, and a focus adjustment unit configured to generate a driving force in the optical axis direction, the focus adjustment unit may include a first magnet disposed on the carrier and a first coil disposed to oppose the first magnet.

The camera module may further include a lens holder coupled to the lens barrel, and an image stabilization unit configured to generate a driving force in the first axis direction and in a second axis direction perpendicular to both the optical axis direction and the first axis direction, the image stabilization unit may include a second magnet and a third magnet disposed on the lens holder, a second coil disposed to oppose the second magnet, and a third coil disposed to oppose the third magnet.

In another general aspect, a camera module includes a housing, a reflective member holder fixedly coupled to the housing, the reflective member holder including a reflective member, a lens barrel disposed closer to an object side than the reflective member, and an image sensor disposed spaced apart from the reflective member in a first axis direction perpendicular to an optical axis direction. The lens barrel is configured to be movable, relatively with respect to the reflective member in one or more axis directions among the optical axis direction, the first axis direction, and a second axis direction perpendicular to both the optical axis direction and the first axis direction.

The reflective member holder may include a flange portion extending in the first axis direction and in the second axis direction, and the flange portion may overlap a bottom surface of the housing in the optical axis direction.

The reflective member holder may include a step portion protruding in the second axis direction toward the housing, and the flange portion and the step portion may overlap each other in the optical axis direction with the bottom surface of the housing interposed therebetween.

The reflective member may include an incident surface on which light passing through the lens barrel is incident, a reflective surface configured to reflect light passing through the incident surface, and an exit surface through which light reflected from the reflective surface exits, and the reflective surface and the exit surface may be spaced apart from each other.

Other features and aspects will be apparent from the following detailed description, the drawings, and the claims.

### BRIEF DESCRIPTION OF DRAWINGS

FIG. 1 is a perspective view of a camera module according to an example embodiment of the present disclosure.

FIG. 2 is an exploded perspective view of the camera module according to an example embodiment of the present disclosure.

FIG. 3 is a schematic cross-sectional view taken along line I-I’ of FIG. 1.

FIG. 4 is a schematic cross-sectional view taken along line II-II’ of FIG. 1.

FIG. 5A is a partially exploded perspective view of a camera module according to an example embodiment of the present disclosure.

FIG. 5B is a perspective view of a state in which a reflective module of FIG. 5A is coupled to a housing.

FIG. 5C is a cutaway perspective view of FIG. 5B.

FIG. 5D is a schematic cross-sectional view taken along line III-III’ of FIG. 5B.

FIGS. 6 and 7 are schematic side views of a reflective member of a camera module according to an example embodiment of the present disclosure.

FIG. 8 is a partially exploded perspective view of a camera module according to an example embodiment of the present disclosure.

FIG. 9 is a schematic side view of a carrier of FIG. 8.

FIG. 10 is a partially exploded perspective view of a camera module according to an example embodiment of the present disclosure.

FIGS. 11 and 12 are cutaway perspective views of a camera module according to an example embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In the present disclosure, an optical axis (Z-axis) direction may refer to a direction, extending vertically along an optical axis (Z-axis) of a lens barrel 210, or a direction, parallel to the optical axis (Z-axis). A first axis (X-axis) direction and a second axis (Y-axis) direction may refer to directions, intersecting the optical axis (Z-axis) direction and perpendicular to each other. For example, the first axis (X-axis) direction may refer to a direction perpendicular to the optical axis (Z-axis) direction, and the second axis (Y-axis) direction may refer to a direction perpendicular to both the optical axis (Z-axis) direction and the first axis (X-axis) direction.

An aspect of the present disclosure is to provide a camera module having a reduced size.

Another aspect of the present disclosure is to provide a camera module having excellent reliability.

However, the aspects of the present disclosure are not limited to those set forth herein, and will be more easily understood in the course of describing specific example embodiments of the present disclosure.

The present disclosure relates to a camera module, and the camera module may be provided in a mobile device. For example, the mobile device may be a portable electronic device such as a smartphone or a tablet PC.

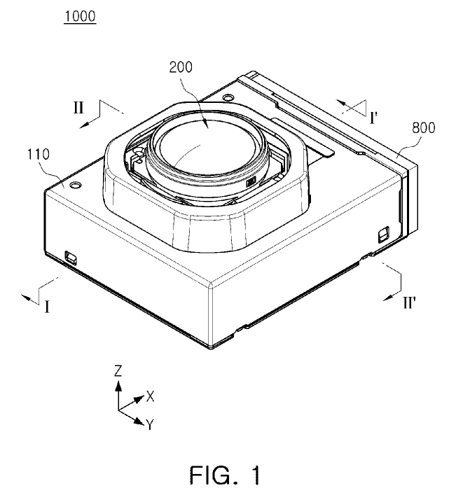

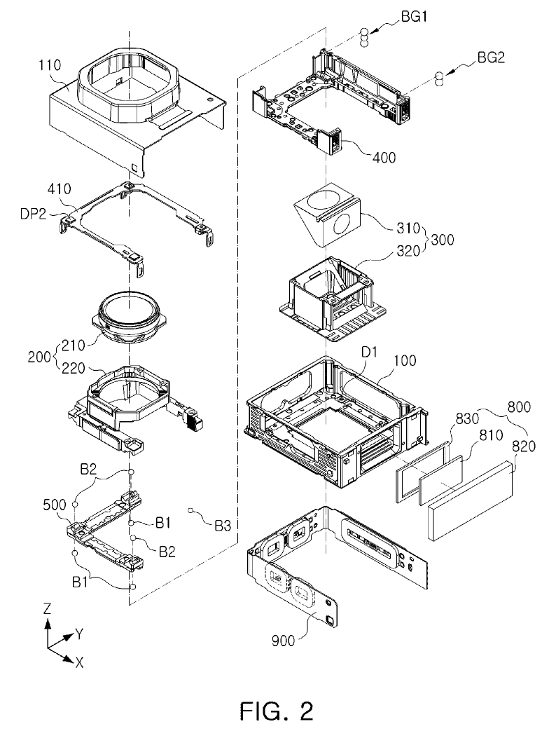

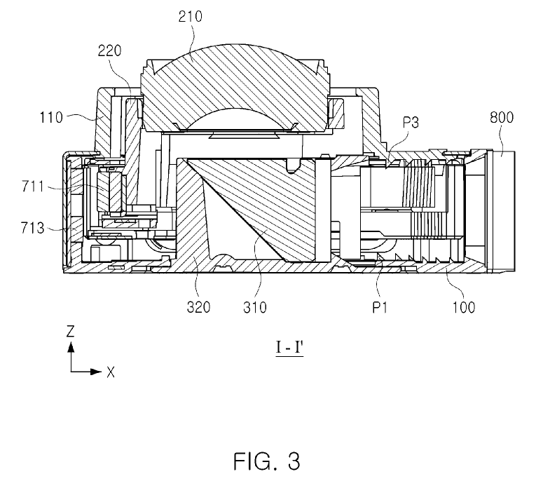

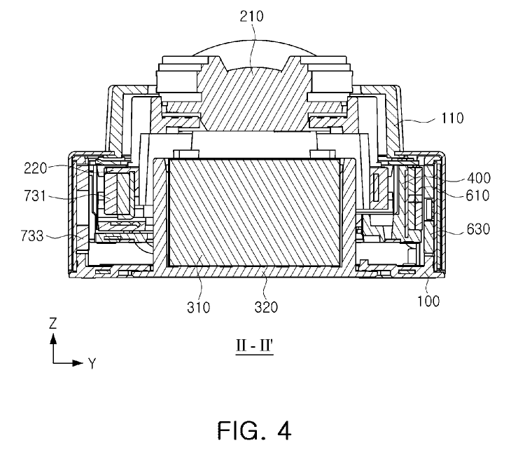

FIG. 1 is a perspective view of a camera module according to an example embodiment of the present disclosure. FIG. 2 is an exploded perspective view of the camera module according to an example embodiment of the present disclosure. FIG. 3 is a schematic cross-sectional view taken along line I-I’ of FIG. 1. FIG. 4 is a schematic cross-sectional view taken along line II-II’ of FIG. 1.

Referring to FIGS. 1 to 4, a camera module 1000 according to an example embodiment of the present disclosure may include a lens module 200, a reflective module 300, and an image sensor module 800. The lens module 200, the reflective module 300, and the image sensor module 800 may be disposed in a housing 100.

The housing 100 may have an open upper portion, and may have a rectangular box shape having an internal space. The lens module 200 and the reflective module 300 may be accommodated in the internal space of the housing 100, and the image sensor module 800 may be disposed on an external surface of the housing 100 such that an imaging surface of the image sensor 810 may oppose the internal space.

Light incident on the camera module 1000 may pass through the lens module 200, and a traveling direction of incident light may be changed by the reflective module 300. For example, the reflective module 300 may include a reflective member 310 reflecting light incident in the optical axis (Z-axis) direction of the camera module 1000 to change a traveling direction of incident light to the first axis (X-axis) direction.

Light incident on the camera module 1000 may sequentially pass through the lens module 200 and the reflective module 300 to be incident on the image sensor 810 of the image sensor module 800, and the image sensor module 800 may convert light into a corresponding electrical signal. For example, the image sensor 810 may be a charge-coupled device (CCD) or a complementary metal-oxide semiconductor (CMOS). The image sensor 810 may be disposed to be spaced apart from the reflective member 310 in the first axis (X-axis) direction. The reflective member 310 may be, for example, one or more of a prism, a mirror, and the like.

A camera module according to the related art, in which a reflective module, a lens module, and an image sensor module are sequentially arranged in an optical axis direction, may be formed to have a long total track length. Thus, it may be disadvantageous for reducing a size of the camera module.

Conversely, in the camera module 1000 according to an example embodiment of the present disclosure, the lens module 200, the reflective module 300, and the image sensor module 800 may be sequentially arranged, but the lens module 200 may be spaced apart from the reflective module 300 in the optical axis (Z-axis) direction, and the image sensor module 800 may be spaced apart from the reflective module 300 in the first axis (X-axis) direction, thereby reducing a total track length of the camera module 1000.

The image sensor module 800 may include an image sensor 810 and a printed circuit board 820 on which the image sensor 810 is mounted. The image sensor module 800 may include an optical filter 830 disposed between the reflective module 300 and the image sensor 810, and the optical filter 830 may filter light having a specific wavelength range. For example, the optical filter 830 may be an infrared blocking filter, blocking light having an infrared wavelength range.

The camera module 1000 may further include a case 110 coupled to the housing 100 to cover the internal space of the housing 100. The case 110 may protect components disposed in the internal space of the housing 100. For example, the case 110 may be formed of a material including metal, and may serve to shield electromagnetic waves.

The lens module 200 may include a lens barrel 210 and a lens holder 220 coupled to the lens barrel 210. The lens barrel 210 may have a hollow cylindrical shape, and at least one lens for imaging a subject may be accommodated in the lens barrel 210. When a plurality of lenses are disposed in the lens barrel 210, the plurality of lenses may be mounted in the lens barrel 210 along the optical axis (Z-axis). A portion of the lens barrel 210 may protrude to the outside of the housing 100.

The lens barrel 210 may be spaced apart from the reflective member 310 in the optical axis (Z-axis) direction. The lens barrel 210 may be disposed in front of the reflective member 310. Here, “in front” may refer to a positive optical axis (Z-axis) direction (+Z-axis direction) with respect to the reflective member 310. For example, the lens barrel 210 may be spaced apart from the reflective member 310 upwardly in the optical axis (Z-axis) direction. For example, the lens barrel 210 may be disposed to be closer to an object side than the reflective member 310. Accordingly, light may pass through the lens barrel 210 to be incident on the reflective member 310.

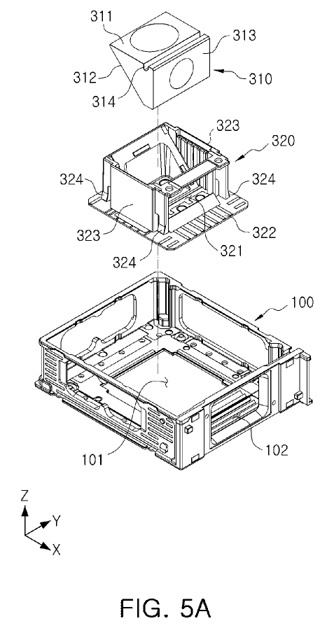

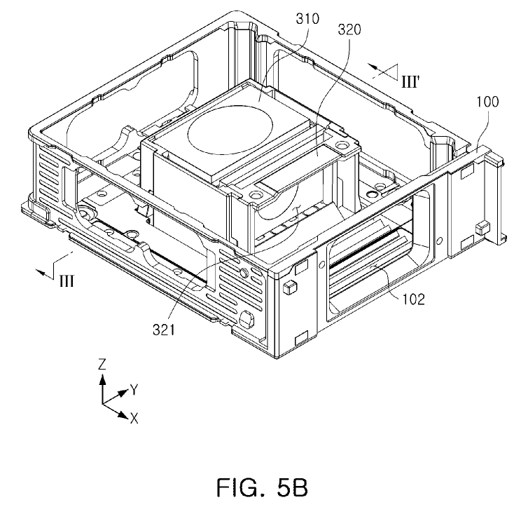

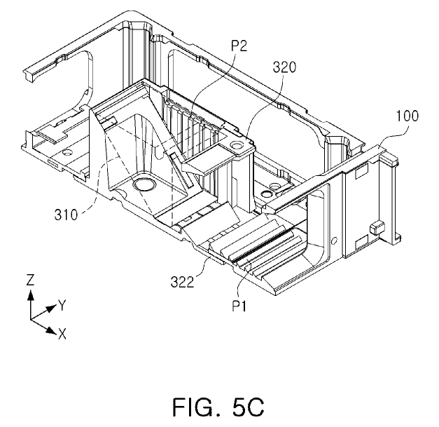

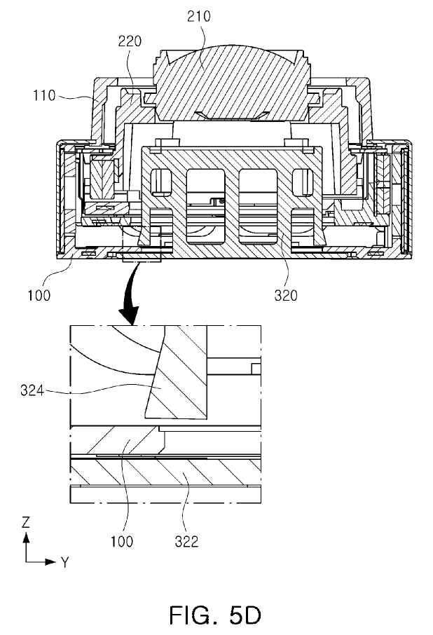

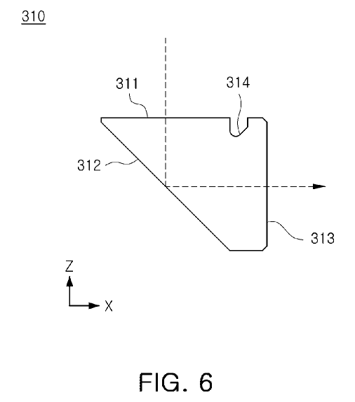

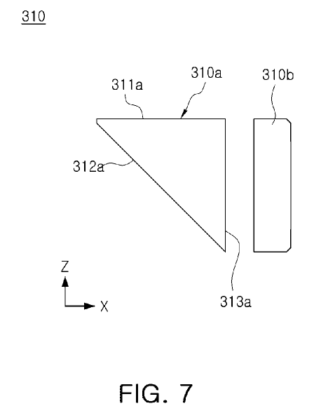

FIG. 5A is a partially exploded perspective view of a camera module according to an example embodiment of the present disclosure. FIG. 5B is a perspective view of a state in which a reflective module of FIG. 5A is coupled to a housing. FIG. 5C is a cutaway perspective view of FIG. 5B. FIG. 5D is a schematic cross-sectional view taken along line III-III’ of FIG. 5B. FIGS. 6 and 7 are schematic side views of a reflective member of a camera module according to an example embodiment of the present disclosure.

The reflective module 300 may include a reflective member 310, and a reflective member holder 320 disposed in the internal space of the housing 100, the reflective member holder 320 including a reflective member 310.

The reflective member 310 may include an incident surface 311 on which light is incident, a reflective surface 312 reflecting light passing through the incident surface 311, and an exit surface 313 through which light reflected from the reflective surface 312 exits. Light, passing through the lens barrel 210, may be incident on the incident surface 311.

The reflective member holder 320 may be coupled to the bottom surface of the housing 100. For example, the reflective member holder 320 may be fixedly coupled to the housing 100.

Referring to FIG. 5A, the bottom surface of the housing 100 may have a first through-hole 101, exposing the internal space of the housing 100 to the outside of the housing 100. The reflective member holder 320 may be disposed in the first through-hole 101.

A side surface of the housing 100 may have a second through-hole 102, exposing the internal space of the housing 100 to the outside of the housing 100, the second through-hole 102 may be disposed between the reflective member 310 and the image sensor 810. The reflective member holder 320 may have an opening 321 disposed to be parallel to the second through-hole 102, the opening 321 may be disposed between the reflective member 310 and the second through-hole 102.

The exit surface 313 of the reflective member 310 and the imaging surface of the image sensor 810 may directly oppose each other through the opening 321 and the second through-hole 102. Accordingly, light reflected from the reflective member 310 may be incident on the imaging surface of the image sensor 810 through the opening 321 and the second through-hole 102.

The reflective member holder 320 may include a flange portion 322, parallel to the bottom surface of the housing 100. For example, the flange portion 322 may extend in the first axis (X-axis) direction and in the second axis (Y-axis) direction. The flange portion 322 may be exposed to the outside of the bottom surface of the housing 100. For example, the flange portion 322 may overlap the bottom surface of the housing 100 in the optical axis (Z-axis) direction, on the outside of the housing 100.

The reflective member holder 320 may include a step portion 324 disposed on a side surface 323 of the reflective member holder 320, the step portion 324 protruding toward the side surface of the housing 100. For example, the step portion 324 may protrude from the side surface 323 of the reflective member holder 320 toward the housing 100 in the second axis (Y-axis) direction.

The reflective member holder 320 may include a plurality of step portions 324. For example, two step portions 324 may be disposed on the side surface 323 of the reflective member holder 320, and the two step portions 324 may be respectively disposed on one side and the other side of the side surface 323 of the reflective member holder 320 in the first axis (X-axis) direction. In addition, the reflective member holder 320 may have two side surfaces 323 opposing each other in the second axis (Y-axis) direction, and the two step portions 324 may be disposed on the two side surfaces 323, respectively. Accordingly, the reflective member holder 320 may include a total of four step portions 324, but the present disclosure is not limited thereto.

When an optical image stabilization (OIS) function is implemented by tilting the reflective member, the reflective member may absorb external impacts while moving when external impacts are applied to the camera module. In the camera module 1000 according to an example embodiment of the present disclosure, the reflective member holder 320, including the reflective member 310, may be fixedly coupled to the housing 100. Accordingly, the reflective member holder 320 may be separated from the housing 100 due to external impacts.

Accordingly, the flange portion 322 and the side surface 323 of the reflective member holder 320 may be disposed to be spaced apart from each other in the optical axis (Z-axis) direction, and a portion of the bottom surface of the housing 100 may extend to a space in which the flange portion 322 and the side surface 323 of the reflective member holder 320 are spaced apart from each other. Thus, the flange portion 322 and the step portion 324 of the reflective member holder 320 may overlap each other in the optical axis (Z-axis) direction with the bottom surface of the housing 100 interposed therebetween.

The flange portion 322 and the step portion 324 of the reflective member holder 320 may overlap each other in the optical axis (Z-axis) direction with the bottom surface of the housing 100 interposed therebetween, such that the reflective member holder 320 may be stably coupled to the housing 100, and may prevent the reflective member holder 320 from being separated from the housing 100 even when external impacts are applied.

The camera module 1000 according to an example embodiment of the present disclosure may include protrusions P1, P2, and P3 for reducing a flare phenomenon.

For example, the bottom surface of the housing 100 may include a plurality of first protrusions P1 disposed between the reflective member holder 320 and the image sensor 810 to protrude toward the internal space of the housing 100, the plurality of first protrusions P1 extending in the second axis (Y-axis) direction. The first protrusion P1 may scatter light, thereby reducing a flare phenomenon caused by unnecessary light. The first protrusion P1 may be provided on the bottom surface of the housing 100 disposed between the opening 321 and the second through-hole 102. The first protrusion P1 may have an inclined surface tilted toward the bottom surface of the housing 100, but the present disclosure is not limited thereto.

For example, the reflective member holder 320 may include a plurality of second protrusions P2 protruding toward a side surface of the reflective member 310, the plurality of second protrusions P2 extending in the optical axis (Z-axis) direction. The second protrusion P2 may scatter light, thereby reducing a flare phenomenon caused by unnecessary light.

For example, referring to FIG. 3, one surface of the case 110, opposing the bottom surface of the housing 100, may include a plurality of third protrusions P3 protruding toward the internal space of the housing 100, the plurality of third protrusions P3 extending in the second axis (Y-axis) direction. The third protrusion P3 may scatter light, thereby reducing a flare phenomenon caused by unnecessary light. The third protrusion P3 may be disposed to oppose, in the optical axis (Z-axis) direction, a region of the bottom surface of the housing 100 in which the first protrusion P1 are disposed. The third protrusion P3 may have an inclined surface tilted toward the bottom surface of the housing 100, but the present disclosure is not limited thereto.

FIGS. 6 and 7 are schematic side views of a reflective member of a camera module according to an example embodiment of the present disclosure.

The reflective member 310 of the camera module 1000 according to an example embodiment of the present disclosure may have a structure for reducing a flare phenomenon.

For example, referring to FIG. 6, the reflective surface 312 and the exit surface 313 of the reflective member 310 may be disposed to be spaced apart from each other in the first axis (X-axis) direction. In the reflective member 310, the reflective surface 312 and the exit surface 313 may be disposed to be spaced apart from each other, thereby reducing a flare phenomenon caused by internal reflection of the reflective member 310.

A groove 314 may be formed on the incident surface 311 of the reflective member 310. For example, the groove 314 may extend in the second axis (Y-axis) direction. The groove 314 may be formed in a region of the incident surface 311, adjacent to the exit surface 313. The groove 314 may scatter light, thereby reducing a flare phenomenon caused by unnecessary light.

For example, referring to FIG. 7, the reflective member 310 may include a first member 310a including an incident surface 311a on which light is incident, a reflective surface 312a reflecting light passing through the incident surface 311a, and an exit surface 313a through which light reflected from the reflective surface 312a exits, and a second member 310b disposed to be spaced apart from the first member 310a in the first axis (X-axis) direction. The second member 310b may be disposed to be parallel to the exit surface 313a. The first member 310a may be provided to change a path of light, and the second member 310b may be provided to reduce a flare phenomenon caused by reflection.

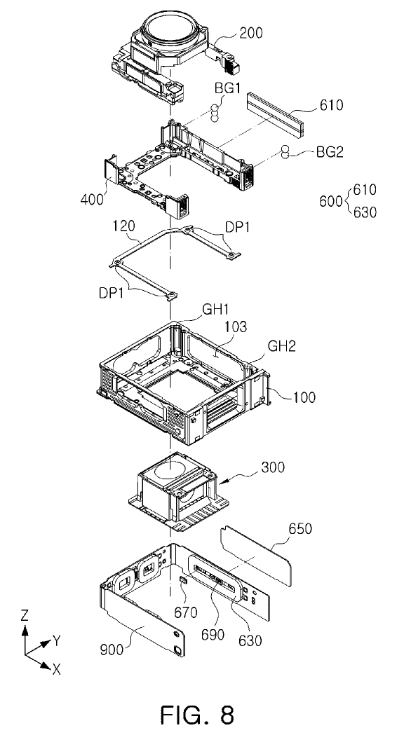

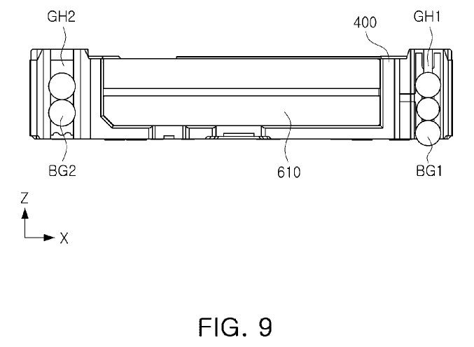

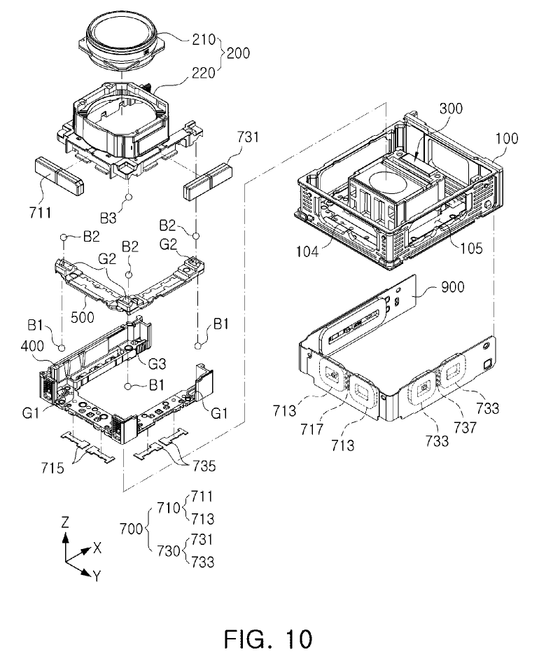

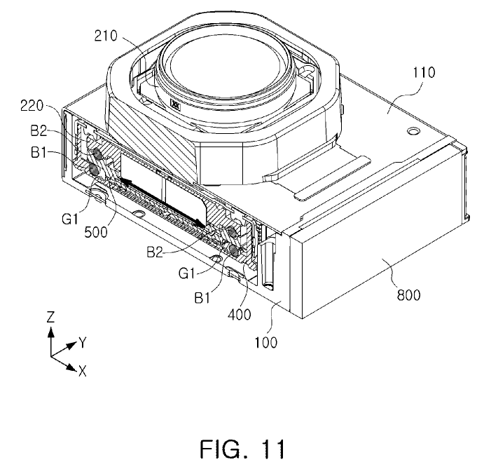

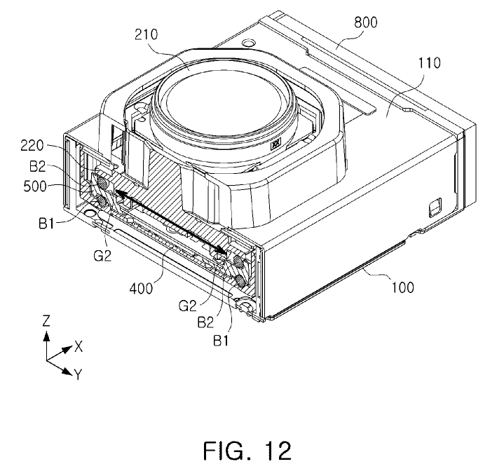

FIG. 8 is a partially exploded perspective view of a camera module according to an example embodiment of the present disclosure. FIG. 9 is a schematic side view of a carrier of FIG. 8. FIG. 10 is a partially exploded perspective view of a camera module according to an example embodiment of the present disclosure. FIGS. 11 and 12 are cutaway perspective views of a camera module according to an example embodiment of the present disclosure.

The camera module 1000 may include a carrier 400 and a guide frame 500. The carrier 400 may be disposed in the housing 100. The carrier 400 may accommodate the lens holder 220 and the guide frame 500. The guide frame 500 may be disposed between the carrier 400 and the lens module 200.

The carrier 400 may have a hollow portion, and may have a shape in which one side of a rectangular frame is open. For example, a planar shape of the carrier 400 may be substantially a “U” shape.

The guide frame 500 may have a hollow portion, and may have a shape in which two sides of a rectangular frame are open. For example, a planar shape of the guide frame 500 may be substantially an “L” shape.

The reflective module 300 may be fixedly coupled to the housing 100, such that the lens module 200 may move, relatively with respect to the reflective module 300, such that an autofocus (AF) function and an optical image stabilization (OIS) function of the camera module 1000 may be performed.

For example, the lens barrel 210, provided in the lens module 200, may be movable, relatively with respect to the reflective member 310 in one or more axis directions, among three axis directions intersecting one another. The lens barrel 210 may move together with the lens holder 220 in a state in which the lens barrel 210 is coupled to the lens holder 220. In an example embodiment, the three axis directions, intersecting each other, may refer to the optical axis (Z-axis) direction, the first axis (X-axis) direction, and the second axis (Y-axis) direction. That is, the lens barrel 210 may be movable, relatively with respect to the reflective member 310 in the one or more axis directions, among the optical axis (Z-axis) direction, the first axis (X-axis) direction, and the second axis (Y-axis) direction.

For example, the lens module 200 may move in the optical axis (Z-axis) direction for focus adjustment, and the lens module 200 may move in a direction perpendicular to the optical axis (Z-axis) for image stabilization.

The camera module 1000 may include a focus adjustment unit 600 moving the lens module 200 in the optical axis (Z-axis) direction. The focus adjustment unit 600 may move the lens module 200 to focus the camera module 1000 on a subject.

Specifically, the focus adjustment unit 600 may generate a driving force in the optical axis (Z-axis) direction to move the carrier 400. The carrier 400 may be movable, relatively with respect to the housing 100 in the optical axis (Z-axis) direction. The lens module 200 may be disposed on the carrier 400, such that the carrier 400 and the lens module 200 may move together in the optical axis (Z-axis) direction due to the driving force of the focus adjustment unit 600. In addition, the guide frame 500 disposed between the lens module 200 and the carrier 400 may also move together with the carrier 400 in the optical axis (Z-axis) direction. The reflective member 310 may be fixed to the housing 100, such that the carrier 400 and the lens module 200 may also be movable, relatively with respect to the reflective member 310.

The focus adjustment unit 600 may include a first magnet 610 and a first coil 630. The first magnet 610 and the first coil 630 may be disposed to oppose each other in a direction perpendicular to the optical axis (Z-axis). For example, the first magnet 610 and the first coil 630 may be disposed to oppose each other in the second axis (Y-axis) direction.

The first magnet 610 may be disposed on the carrier 400. For example, the first magnet 610 may be mounted on one side surface of the carrier 400.

The first magnet 610 may be magnetized such that one surface (for example, a surface opposing the first coil 630) of the first magnet 610 has both an N pole and an S pole. For example, the one surface of the first magnet 610, opposing the first coil 630, may sequentially include an N pole, a neutral region, and an S pole in the optical axis (Z-axis) direction.

The first coil 630 may be disposed on a main substrate 900, and the main substrate 900 may be mounted in the housing 100 such that the first magnet 610 and the first coil 630 oppose each other in a direction perpendicular to the optical axis (Z-axis). For example, the main substrate 900 may be mounted on the side surface of the housing 100 such that the first magnet 610 and the first coil 630 oppose each other in a direction perpendicular to the optical axis (Z-axis).

The side surface of the housing 100 may have a third through-hole 103, exposing the internal space of the housing 100 to the outside of the housing 100. The first coil 630, disposed on the main substrate 900, may directly oppose the first magnet 610 through the third through-hole 103.

During focus adjustment, the first magnet 610 may be a movable member mounted on the carrier 400 to move together with the carrier 400 in the optical axis (Z-axis) direction, and the first coil 630 may be a fixed member fixed to the main substrate 900.

When power is applied to the first coil 630, the carrier 400 may move in the optical axis (Z-axis) direction due to an electromagnetic force between the first magnet 610 and the first coil 630. The lens module 200 may be disposed on the carrier 400, such that the lens module 200 may also move in the optical axis (Z-axis) direction due to movement of the carrier 400.

Ball groups BG1 and BG2 may be disposed between the carrier 400 and the housing 100. For example, the ball groups BG1 and BG2 may be disposed between the carrier 400 and the side surface of the housing 100 to reduce friction when the carrier 400 moves.

The ball groups BG1 and BG2 may include a plurality of balls disposed in the optical axis (Z-axis) direction. The plurality of balls may move in a rolling manner in the optical axis (Z-axis) direction when the carrier 400 moves in the optical axis (Z-axis) direction.

The ball groups BG1 and BG2 may include a first ball group BG1 and a second ball group BG2, and each of the first ball group BG1 and the second ball group BG2 may include one or more balls. The first ball group BG1 and the second ball group BG2 may be disposed to be spaced apart from each other in a direction perpendicular to the optical axis (Z-axis). For example, the first ball group BG1 and the second ball group BG2 may be disposed to be spaced apart from each other in the first axis (X-axis) direction.

A guide groove may be disposed on each of surfaces of the carrier 400 and the housing 100, opposing each other. For example, a first guide groove GH1, accommodating the first ball group BG1, and a second guide groove GH2, accommodating the second ball group BG2, may be disposed on the surfaces of the carrier 400 and the housing 100 opposing each other, respectively. Each of the first guide groove GH1 and the second guide groove GH2 may extend in the optical axis (Z-axis) direction.

A first yoke 650 may be disposed in the housing 100. The first yoke 650 may be disposed at a position opposing the first magnet 610. For example, the first coil 630 may be disposed on one surface of the main substrate 900, and the first yoke 650 may be disposed on an opposite surface of the one surface of the main substrate 900 on which the first coil 630 is disposed.

The first magnet 610 and the first yoke 650 may generate an attractive force therebetween. For example, the first yoke 650 may be formed of a magnetic material. The attractive force may act between the first magnet 610 and the first yoke 650 in a direction perpendicular to the optical axis (Z-axis). For example, the attractive force between the first magnet 610 and the first yoke 650 may act in the second axis (Y-axis) direction.

Due to the attractive force between the first magnet 610 and the first yoke 650, the ball groups BG1 and BG2 may be in contact with the carrier 400 and the housing 100, respectively, and the carrier 400 may be closely supported by the housing 100.

The number of balls in the first ball group BG1 and the number of balls in the second ball group BG2 may be different from each other. For example, the number of balls included in the first ball group BG1 may be greater than the number of balls included in the second ball group BG2.

For example, the first ball group BG1 may include two or more balls disposed in the optical axis (Z-axis) direction, and the number of balls included in the second ball group BG2 may be less than the number of balls included in the first ball group BG1.

Under the assumption that the number of balls in the first ball group BG1 is different from the number of balls in the second ball group BG2, the number of balls in each ball group may be changed. For convenience of description, the following description is based on an example in which the first ball group BG1 includes three balls and the second ball group BG2 includes two balls.

Among the three balls included in the first ball group BG1, outermost two balls in a direction, parallel to the optical axis (Z-axis), may have the same diameter, and one ball disposed between the outermost balls may have a diameter smaller than that of the outermost balls. The two balls included in the second ball group BG2 may have the same diameter.

Among the three balls included in the first ball group BG1, each of the outermost two balls in a direction, parallel to the optical axis (Z-axis), may be in contact with the carrier 400 at two points, and may be in contact with the housing 100 at two points.

Each of the two balls of the second ball group BG2 may be in contact with the carrier 400 at one point, and may be in contact with the housing 100 at two points (or vice versa).

The first ball group BG1 and the first guide groove GH1 may function as main guides guiding movement of the carrier 400 in the optical axis (Z-axis) direction, and the second ball group BG2 and the second guide groove GH2 may function as auxiliary guides supporting movement of the carrier 400 in the optical axis (Z-axis) direction.

In an example embodiment, an auxiliary yoke 670 may be disposed at a position opposing the first magnet 610. For example, the auxiliary yoke 670 may be disposed on the main substrate 900 to oppose the first magnet 610. The auxiliary yoke 670 may be disposed on the inside of the first coil 630.

The auxiliary yoke 670 may be positioned to be closer to the first ball group BG1 than to the second ball group BG2. The auxiliary yoke 670 may generate an attractive force with respect to the first magnet 610, together with the first yoke 650.

Accordingly, a resultant force of the attractive force acting between the first magnet 610 and the first yoke 650 and the attractive force generated between the first magnet 610 and the auxiliary yoke 670 may be positioned to be closer to the first ball group BG1 than to the second ball group BG2.

In an example embodiment, the camera module 1000 may detect a position of the carrier 400 in the optical axis (Z-axis) direction. To this end, a first position sensor 690 may be provided. The first position sensor 690 may be disposed on the main substrate 900 to oppose the first magnet 610.

For example, the first position sensor 690 may be disposed on the inside of the first coil 630, and may be positioned to oppose the neutral region of the first magnet 610. The first position sensor 690 may be a Hall sensor.

The camera module 1000 may include an image stabilization unit 700 moving the lens module 200 in a direction perpendicular to the optical axis (Z-axis). When an image is captured, the image stabilization unit 700 may move the lens module 200 to stabilize the image.

Specifically, the image stabilization unit 700 may generate a driving force in the first axis (X-axis) direction and in the second axis (Y-axis) direction to move the lens module 200. For example, due to the driving force of the image stabilization unit 700, the guide frame 500 and the lens module 200 may move in the first axis (X-axis) direction, relatively with respect to the carrier 400, and the lens module 200 may move in the second axis (Y-axis) direction, relatively with respect to the guide frame 500.

The image stabilization unit 700 may include a first sub-image stabilization unit 710 and a second sub-image stabilization unit 730. The first sub-image stabilization unit 710 may generate a driving force in the first axis (X-axis) direction. The second sub-image stabilization unit 730 may generate a driving force in the second axis (Y-axis) direction.

The first sub-image stabilization unit 710 may include a second magnet 711 and a second coil 713. The second magnet 711 and the second coil 713 may be disposed to oppose each other in a direction perpendicular to the optical axis (Z-axis). For example, the second magnet 711 and the second coil 713 may be disposed to oppose each other in the first axis (X-axis) direction.

The second magnet 711 may be disposed on the lens holder 220. For example, the second magnet 711 may be mounted on one side surface of the lens holder 220;

The second magnet 711 may be magnetized such that one surface (for example, a surface opposing the second coil 713) of the second magnet 711 has both an N pole and an S pole. For example, the one surface of the second magnet 711, opposing the second coil 713, may sequentially include an N pole, a neutral region, and an S pole in the second axis (Y-axis) direction.

The second coil 713 may include two coils. One of the two coils of the second coil 713 may be disposed to oppose the N pole of the second magnet 711, and the other one of the two coils of the second coil 713 may be disposed to oppose the S pole of the second magnet 711. Due to a polarity arrangement form of the second magnet 711, magnetic field leakage may be prevented, and thus a sufficient driving force may be generated even with low power.

The second coil 713 may be disposed on the main substrate 900, and the main substrate 900 may be mounted in the housing 100, such that the second magnet 711 and the second coil 713 may oppose each other in a direction perpendicular to the optical axis (Z-axis).

A side surface of the housing 100 may have a fourth through-hole 104, exposing the internal space of the housing 100 to the outside of the housing 100. The second coil 713, disposed on the main substrate 900, may directly oppose the second magnet 711 through the fourth through-hole 104.

During image stabilization, the second magnet 711 may be a movable member moving together with the lens holder 220 in a direction perpendicular to the optical axis (Z-axis), and the second coil 713 may be a fixed member fixed to the main substrate 900.

When power is applied to the second coil 713, the lens holder 220 and the guide frame 500 may move, relatively with respect to the carrier 400 in the first axis (X-axis) direction due to an electromagnetic force between the second magnet 711 and the second coil 713.

The second sub-image stabilization unit 730 may include a third magnet 731 and a third coil 733. The third magnet 731 and the third coil 733 may be disposed to oppose each other in a direction perpendicular to the optical axis (Z-axis). For example, the third magnet 731 and the third coil 733 may be disposed to oppose each other in the second axis (Y-axis) direction.

The third magnet 731 may be disposed on the lens holder 220. For example, the third magnet 731 may be mounted on one side surface of the lens holder 220.

The third magnet 731 may be magnetized such that one surface (for example, a surface opposing the third coil 733) of the third magnet 731 has both an N pole and an S pole. For example, the one surface of the third magnet 731, opposing the third coil 733, may sequentially include an N pole, a neutral region, and an S pole in the first axis (X-axis) direction.

The third coil 733 may include two coils. One of the two coils of the third coil 733 may be disposed to oppose the N pole of the third magnet 731, and the other one of the two coils of the third coil 733 may be disposed to oppose the S pole of the third magnet 731. Due to a polarity arrangement form of the third magnet 731, magnetic field leakage may be prevented, and thus a sufficient driving force may be generated even with low power.

The third coil 733 may be disposed on the main substrate 900, and the main substrate 900 may be mounted in the housing 100 such that the third magnet 731 and the third coil 733 oppose each other in a direction perpendicular to the optical axis (Z-axis).

A side surface of the housing 100 may have a fifth through-hole 105, exposing the internal space of the housing 100 to the outside of the housing 100. The third coil 733, disposed on the main substrate 900, may directly oppose the third magnet 731 through the fifth through-hole 105.

During image stabilization, the third magnet 731 may be a movable member moving together with the lens holder 220 in a direction perpendicular to the optical axis (Z-axis), and the third coil 733 may be a fixed member fixed to the main substrate 900.

When power is applied to the third coil 733, the lens holder 220 may move, relatively with respect to the guide frame 500 in the second axis (Y-axis) direction due to an electromagnetic force between the third magnet 731 and the third coil 733.

The camera module 1000 according to an example embodiment of the present disclosure may include a plurality of ball members, supporting the guide frame 500 and the lens module 200. The plurality of ball members may perform a function of guiding movement of the guide frame 500 and the lens module 200 during image stabilization, and a function of maintaining a distance between the carrier 400, the guide frame 500, and the lens module 200.

The plurality of ball members may include a first ball member B1, a second ball member B2, and a third ball member B3. The first ball member B1 may be disposed between the carrier 400 and the guide frame 500, the second ball member B2 may be disposed between the guide frame 500 and the lens module 200, and the third ball member B3 may be disposed between the carrier 400 and the lens module 200.

The first ball member B1 may guide movement of the guide frame 500 and the lens module 200 with respect to the carrier 400 in the first axis (X-axis) direction, and the second ball member B2 may guide movement of the lens module 200 with respect to the guide frame 500 in the second axis (Y-axis) direction.

When a driving force in the first axis (X-axis) direction is generated, the first ball member B1 may move in a rolling manner in the first axis (X-axis) direction. Accordingly, the first ball member B1 may guide movement of the guide frame 500 and the lens module 200 in the first axis (X-axis) direction.

When a driving force in the second axis (Y-axis) direction is generated, the second ball member B2 may move in a rolling manner in the second axis (Y-axis) direction. Accordingly, the second ball member B2 may guide movement of the lens module 200 in the second axis (Y-axis) direction.

In addition, when a driving force in the first axis (X-axis) direction and/or in the second axis (Y-axis) direction is generated, the third ball member B3 may rotate in place, and the third ball member B3 may be disposed between the lens module 200 and the carrier 400 to support the lens module 200.

The first ball member B1 may include a plurality of balls disposed between the carrier 400 and the guide frame 500, and the second ball member B2 may include a plurality of balls disposed between the guide frame 500 and the lens module 200. For example, each of the first ball member B1 and the second ball member B2 may include three balls.

A first groove portion G1, accommodating the first ball member B1, may be formed on at least one of surfaces of the carrier 400 and the guide frame 500 opposing each other in the optical axis (Z-axis) direction. The first groove portion G1 may include a plurality of grooves corresponding to the plurality of balls of the first ball member B1.

The first ball member B1 may be accommodated in the first groove portion G1, and may be inserted between the carrier 400 and the guide frame 500.

The first ball member B1, in a state of being accommodated in the first groove portion G1, may be restricted in movement in the optical axis (Z-axis) direction and in the second axis (Y-axis) direction, and may move only in the first axis (X-axis) direction. For example, the first ball member B1 may be movable in a rolling manner only in the first axis (X-axis) direction.

To this end, the first groove portion G1 may extend in the first axis (X-axis) direction, and a planar shape of the first groove portion G1 may be a rectangular shape having a length in the first axis (X-axis) direction.

A second groove portion G2, accommodating the second ball member B2, may be formed on at least one of surfaces of the guide frame 500 and the lens module 200 (for example, the lens holder 220) opposing each other in the optical axis (Z-axis) direction. The second groove portion G2 may include a plurality of grooves corresponding to the plurality of balls of the second ball member B2.

The second ball member B2 may be accommodated in the second groove portion G2, and may be inserted between the guide frame 500 and the lens module 200.

The second ball member B2, in a state of being accommodated in the second groove portion G2, may be restricted in movement in the optical axis (Z-axis) direction and in the first axis (X-axis) direction, and may move only in the second axis (Y-axis) direction. For example, the second ball member B2 may move in a rolling manner only in the second axis (Y-axis) direction.

To this end, the second groove portion G2 may extend in the second axis (Y-axis) direction, and a planar shape of the second groove portion G2 may be a rectangular shape having a length in the second axis (Y-axis) direction.

When a driving force in the first axis (X-axis) direction is generated, the guide frame 500 and the lens module 200 may move together in the first axis (X-axis) direction. Here, the first ball member B1 may move in a rolling manner along the first axis (X-axis), and movement of the second ball member B2 may be restricted by the second groove portion G2.

When a driving force in the second axis (Y-axis) direction is generated, the lens module 200 may move, relatively with respect to the guide frame 500 in the second axis (Y-axis) direction. Here, the second ball member B2 may move in a rolling manner along the second axis (Y-axis), and movement of the first ball member B1 may be restricted by the first groove portion G1.

A third groove portion G3, accommodating the third ball member B3, may be formed on surfaces of the carrier 400 and the lens module 200 (for example, the lens holder 220), opposing each other in the optical axis (Z-axis) direction.

The third ball member B3 may be accommodated in the third groove portion G3, and may be inserted between the carrier 400 and the lens module 200. The third ball member B3 may be disposed on one side of the carrier 400 to oppose the lens holder 220 through an open region of the guide frame 500.

For example, a planar shape of the third groove portion G3 may be a circular shape, but the present disclosure is not limited thereto.

The carrier 400 may include a second yoke 715 and a third yoke 735. The second yoke 715 may be disposed at a position opposing the second magnet 711 in the optical axis (Z-axis) direction, and the third yoke 735 may be disposed at a position opposing the third magnet 731 in the optical axis (Z-axis) direction. For example, the second yoke 715 and the third yoke 735 may be disposed on a bottom surface of the carrier 400.

The second magnet 711 and the second yoke 715 may generate an attractive force therebetween, and the third magnet 731 and the third yoke 735 may generate an attractive force therebetween. For example, the second yoke 715 and the third yoke 735 may be formed of a magnetic material. The attractive force may act between the second magnet 711 and the second yoke 715 in the optical axis (Z-axis) direction, and the attractive force may act between the third magnet 731 and the third yoke 735 in the optical axis (Z-axis) direction.

Due to the attractive force between the second magnet 711 and the second yoke 715 and the attractive force between the third magnet 731 and the third yoke 735, the first ball member B1 may be in contact with the carrier 400 and the guide frame 500, and the second ball member B2 may be in contact with the guide frame 500 and the lens module 200, and the guide frame 500 and the lens module 200 may be closely supported by the carrier 400.

In an example embodiment, the camera module 1000 may detect a position of the lens module 200 in a direction perpendicular to the optical axis (Z-axis). To this end, a second position sensor 717 and a third position sensor 737 may be provided. The second position sensor 717 may be disposed on the main substrate 900 to oppose the second magnet 711, and the third position sensor 737 may be disposed on the main substrate 900 to oppose the third magnet 731.

For example, the second position sensor 717 may be disposed between two coils of the second coil 713, and the third position sensor 737 may be disposed between two coils of the third coil 733. The second position sensor 717 may be disposed to oppose the neutral region of the second magnet 711, and the third position sensor 737 may be disposed to oppose the neutral region of the third magnet 731. The second position sensor 717 and the third position sensor 737 may be Hall sensors.

Referring to FIGS. 2 and 8, in an example embodiment, a bottom surface of the housing 100 may include a first damper DP1. The first damper DP1 may be disposed to oppose the carrier 400 in the optical axis (Z-axis) direction. When external impacts are applied to the camera module 1000, the first damper DP1 may collide with the carrier 400, thereby preventing the carrier 400 from colliding with other components within the camera module 1000.

A plurality of first dampers DP1 may be disposed in the housing 100. For example, the housing 100 may include four dampers, but the present disclosure is not limited thereto.

The first damper DP1 may be integrally formed with the housing 100 via a support frame 120. For example, the first damper DP1 may be mounted on the support frame 120, and the support frame 120 may be inserted into the housing 100 to be integrally provided with the housing 100.

Referring to FIG. 2, in an example embodiment, a stopper 410 may be coupled to the carrier 400. The stopper 410 may be coupled to the carrier 400 to cover at least a portion of an upper surface of the lens module 200. For example, the stopper 410 may cover at least a portion of an upper surface of the lens holder 220.

The stopper 410 may prevent the guide frame 500 and the lens module 200 from being separated to the outside of the carrier 400 due to external impacts or the like.

An upper surface of the stopper 410, opposing the case 110, may include a second damper DP2. The second damper DP2 may be disposed to oppose the case 110 in the optical axis (the Z-axis) direction. When an external impact is applied to the camera module 1000, the second damper DP2 may collide with the case 110. Accordingly, it is possible to prevent the case 110 from colliding with other components within the camera module 1000.

A plurality of second dampers DP2 may be disposed on the stopper 410. For example, the second damper DP2 may include four dampers disposed on a corner portion of the stopper 410, but the present disclosure is not limited thereto.

A material of the first damper DP1 and the second damper DP2 is not limited, but the material may be a material including an elastic material such as urethane, rubber, silicone, sponge, or the like.

Referring to FIGS. 4 and 8, in an example embodiment, at least a portion of the focus adjustment unit 600 may be disposed to overlap the reflective member 310 in a direction perpendicular to the optical axis (Z-axis).

For example, a portion of the first magnet 610 and a portion of the first coil 630 may be disposed to overlap the reflective member 310 in a direction in which the first magnet 610 and the first coil 630 oppose each other.

At least a portion of the first magnet 610 may be disposed to be spaced apart from the reflective member 310 in the second axis (Y-axis) direction. In addition, at least a portion of the first coil 630 may be disposed to be spaced apart from the reflective member 310 in the second axis (Y-axis) direction.

At least a portion of the focus adjustment unit 600 may be disposed to overlap the reflective member 310 in a direction perpendicular to the optical axis (Z-axis), such that a size (for example, a height in the optical axis (Z-axis) direction) of the camera module 1000 may be reduced.

Referring to FIGS. 3, 4, and 10, in an example embodiment, at least a portion of the image stabilization unit 700 may be disposed to overlap the reflective member 310 in a direction perpendicular to the optical axis (Z-axis).

For example, at least a portion of the second magnet 711 and at least a portion of the second coil 713 may be disposed to overlap the reflective member 310 in a direction in which the second magnet 711 and the second coil 713 oppose each other. At least a portion of the third magnet 731 and at least a portion of the third coil 733 may be disposed to overlap the reflective member 310 in a direction in which the third magnet 731 and the third coil 733 oppose each other.

At least a portion of the second magnet 711 may be disposed to be spaced apart from the reflective member 310 in the first axis (X-axis) direction. In addition, at least a portion of the second coil 713 may be disposed to be spaced apart from the reflective member 310 in the first axis (X-axis) direction.

At least a portion of the third magnet 731 may be disposed to be spaced apart from the reflective member 310 in the second axis (Y-axis) direction. In addition, at least a portion of the third coil 733 may be disposed to be spaced apart from the reflective member 310 in the second axis (Y-axis) direction.

At least a portion of the image stabilization unit 700 may be disposed to overlap the reflective member 310 in a direction perpendicular to the optical axis (Z-axis), such that a size (for example, a height in the optical axis (Z-axis) direction) of the camera module 1000 may be reduced.

According to example embodiments of the present disclosure, a cameral module may have a reduced size.

According to example embodiments of the present disclosure, a camera module may have excellent reliability.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing having an internal space;
a reflective member holder disposed in the internal space, the reflective member holder comprising a reflective member;
a lens barrel spaced apart from the reflective member in an optical axis direction; and
an image sensor spaced apart from the reflective member in a first axis direction intersecting the optical axis direction,
wherein the reflective member holder is coupled to a bottom surface of the housing, and
wherein the lens barrel is configured to be movable, relatively with respect to the reflective member in one or more axis directions among three axis directions intersecting one another.

2. The camera module of claim 1, wherein
the bottom surface of the housing comprises a first through-hole exposing the internal space to the outside of the housing, and
the reflective member holder is disposed in the first through-hole.

3. The camera module of claim 1, wherein
a side surface of the housing comprises a second through-hole exposing the internal space to the outside of the housing, the second through-hole disposed between the reflective member and the image sensor, and
the reflective member holder comprises an opening disposed parallel to the second through-hole, the opening disposed between the reflective member and the second through-hole.

4. The camera module of claim 1, wherein
the three axis directions are the optical axis direction, the first axis direction, and a second axis direction perpendicular to both the optical axis direction and the first axis direction, and
the lens barrel is spaced apart from the reflective member upwardly in the optical axis direction.

5. The camera module of claim 1, wherein
the reflective member holder comprises a flange portion parallel to the bottom surface of the housing, and
the flange portion is exposed to the outside of the bottom surface of the housing.

6. The camera module of claim 5, wherein the flange portion overlaps the bottom surface of the housing in the optical axis direction.

7. The camera module of claim 5, wherein a step portion, protruding toward a side surface of the housing, is disposed on a side surface of the reflective member holder.

8. The camera module of claim 7, wherein the flange portion and the step portion overlap each other in the optical axis direction with the bottom surface of the housing interposed therebetween.

9. The camera module of claim 1, wherein the bottom surface of the housing comprises a plurality of first protrusions disposed between the reflective member holder and the image sensor to protrude toward the internal space, the plurality of first protrusions extending in a second axis direction perpendicular to both the optical axis direction and the first axis direction.

10. The camera module of claim 1, wherein the reflective member holder comprises a plurality of second protrusions protruding toward a side surface of the reflective member, the plurality of second protrusions extending in the optical axis direction.

11. The camera module of claim 1, wherein
the reflective member comprises an incident surface on which light is incident, a reflective surface configured to reflect light passing through the incident surface, and an exit surface through which light reflected from the reflective surface exits, and
the reflective surface and the exit surface are spaced apart from each other.

12. The camera module of claim 1, further comprising:
a lens holder coupled to the lens barrel;
a carrier accommodating the lens holder; and
a focus adjustment unit configured to generate a driving force in the optical axis direction, the focus adjustment unit comprising a first magnet disposed on the carrier and a first coil disposed to oppose the first magnet.

13. The camera module of claim 1, further comprising:
a lens holder coupled to the lens barrel; and
an image stabilization unit configured to generate a driving force in the first axis direction and in a second axis direction perpendicular to both the optical axis direction and the first axis direction, the image stabilization unit comprising a second magnet and a third magnet disposed on the lens holder, a second coil disposed to oppose the second magnet, and a third coil disposed to oppose the third magnet.

14. A camera module comprising:
a housing;
a reflective member holder fixedly coupled to the housing, the reflective member holder comprising a reflective member;
a lens barrel disposed closer to an object side than the reflective member; and
an image sensor disposed spaced apart from the reflective member in a first axis direction perpendicular to an optical axis direction,
wherein the lens barrel is configured to be movable, relatively with respect to the reflective member in one or more axis directions among the optical axis direction, the first axis direction, and a second axis direction perpendicular to both the optical axis direction and the first axis direction.

15. The camera module of claim 14, wherein
the reflective member holder comprises a flange portion extending in the first axis direction and in the second axis direction, and
the flange portion overlaps a bottom surface of the housing in the optical axis direction.

16. The camera module of claim 15, wherein
the reflective member holder comprises a step portion protruding in the second axis direction toward the housing, and
the flange portion and the step portion overlap each other in the optical axis direction with the bottom surface of the housing interposed therebetween.

17. The camera module of claim 14, wherein
the reflective member comprises an incident surface on which light passing through the lens barrel is incident, a reflective surface configured to reflect light passing through the incident surface, and an exit surface through which light reflected from the reflective surface exits, and
the reflective surface and the exit surface are spaced apart from each other.
